(19) United States
(12) Patent Application Publication
(10) Pub. No.: US 2004/0174161 A1
(43) Pub. Date: Sep. 9, 2004

(54) Position sensing system

(76) Inventors: Wolfgang Tausch, Bad Oeynhausen (DE); Torsten Wedemeyer, Porta Westfalica (DE)

Correspondence Address: Gauthier & Connors LLP, Suite 3300, 225 Franklin Street, Boston, MA, 02110, US

(21) Appl. No.: 10/774,894

(22) Filed: Feb. 9, 2004

(30) Foreign Application Priority Data
Feb. 12, 2003 (DE) 20302273.4

(51) Int. Cl. G01B 7/14

(52) U.S. Cl. 324/207.22; 187/394; 324/207.24; 341/15

(57) ABSTRACT

A position sensing system, specifically for elevators, comprising at least one sensor which is able to move relative to a transducer for the sensor. According to the invention, a scale is provided as a transducer, to which scale a code (11-15, 19) detectable by the sensor is applied by which the position of the sensor relative to the scale is able to be measured. As a result, it is possible to detect the absolute height of the elevator car, with the result that, depending on the code, a high level of precision may be achieved. In addition, the position sensing system may be employed for automated start-up operation, and the data measured may be utilized both for the control equipment and to meet safety requirements.

### BACKGROUND OF THE INVENTION

1. Field of the Invention

The invention relates to a position sensing system, specifically for elevators, comprising at least one sensor which is able to move relative to a transducer for the sensor.

2. Description of the Prior Art

Sensing systems of this type may be employed specifically for passenger and freight elevators for a control system.

Position sensing systems already exist for elevators that utilize incremental encoders, magnetic switches, mechanical position switches, or even an ultrasound-based system. Usually in such cases there are two separate systems for the control equipment and the safety equipment. Particularly in the case of multistory systems, the measurement resolution is usually too low, a factor which degrades comfort. When incremental systems are reset, they lose positional information and must therefore be recalibrated—a relatively complex and expensive procedure. Nonpositive-engaging, positive-engaging, and contact-based solutions have the problem that their service life is often short, with the resulting failure problems. In the event of a problem, the diagnosis required to clear the problem is often difficult, and the resulting out-of-service times are long. Prior-art systems have relatively high maintenance costs and require complex and expensive adjustment on site. Additional problems arise if many different components are distributed throughout the shaft, with the resulting complex wiring.

### SUMMARY OF THE INVENTION

The goal of the invention is therefore to create a position sensing system, specifically, for elevators, which provides reliable position sensing, together with high precision and a simple design.

This goal is achieved by a position sensing system having the features of Claim 1.

If the transducer is a scale on which a code is provided that is detectable by the sensor, by which code the position of the sensor relative to the scale is measurable, it is then possible to detect the absolute height of the elevator car, with the result that, depending on the code, a high level of precision may be achieved. The position sensing system may be employed for an automated start-up operation, and the data thus measured may be utilized both for the control equipment and for the purpose of meeting safety requirements. In addition to this application for the control and safety of an elevator, the position sensing system may also be employed for automated monitoring and diagnostic procedures in response to failures.

According to a preferred embodiment of the invention, detection of positions is implemented by the sensor using a non-contact solution in order to minimize wear. The scale with the code preferably has multiple magnetic fields readable by sensors. However, it is also possible to use optical, inductive, capacitive, or high-frequency systems to implement position sensing. In the case of magnetic systems, the preferred components used include permanent-magnet-based or electromagnetic elements, magneto-resistive elements, Hall effect devices, or Reed contacts.

The scale preferably has at least two different, adjacently arranged codes. The code with the larger scale may be used exclusively for safety-related purposes, while the code with the smaller scale may be utilized for control purposes. It is also possible to implement redundant position sensing using multiple codes. In this case, a comparator is preferably provided which compares the position data and/or speed data measured by the two sensors in order to achieve a higher level of safety.

### BRIEF DESCRIPTION OF THE DRAWINGS

The following discussion explains the invention in more detail based on several embodiments which reference the attached drawings.

FIG. 1 is a schematic view of an elevator on which a position sensing system according to the invention may be installed;

FIG. 2 shows several embodiments for the codes;

FIG. 3 shows an embodiment with a combination of codes; and

FIG. 4 shows several embodiments for additional codes.

### DETAILED DESCRIPTION OF THE INVENTION

In the case of the elevator system shown in FIG. 1, a car 1 is located so as to travel inside a shaft and be moved by a belt 2 or by wire cables. Belt 2 is routed around a driven return pulley 3, while a counterweight is located on the opposite side. A machinery room 6 including a control system 7 is located, together with the requisite safety equipment 8, in the top section of the elevator shaft.

Multiple doors 9 are located at various levels along the front side of the elevator shaft, to which doors car 1 moves. Buffers 10 are installed at the base to provide safety. A wall 30 is provided at the rear which may be utilized by car 1 for position sensing.

A scale is located in the shaft on rear wall 30 adjacent to car 1. The scale has a code which is readable by a sensor connected to the car, thereby providing for noncontact reading of the position of car 1. Reading the code additionally allows the speed of car 1 to be measured. The data measured by the sensor are transmitted to the control system regulating the drive unit and to safety equipment 8. In the embodiment shown, the scale inside the shaft and the sensor are connected to the car. It is of course also feasible to locate one or more sensors inside the shaft and to place the scale on the car.

The scale may be a vertically oriented strip, a bar, or a tape on which magnets are arranged with alternating poles (north and south). The alternating poles provide identification which may be read by the corresponding magnetic sensors. The position on the scale or tape is encoded by the alternating magnetic field. A sufficient number of sensors is located on the car, thereby enabling noncontact detection of the magnetic data. Another feasible approach would be to connect the scale or the sensors to the movable belt.

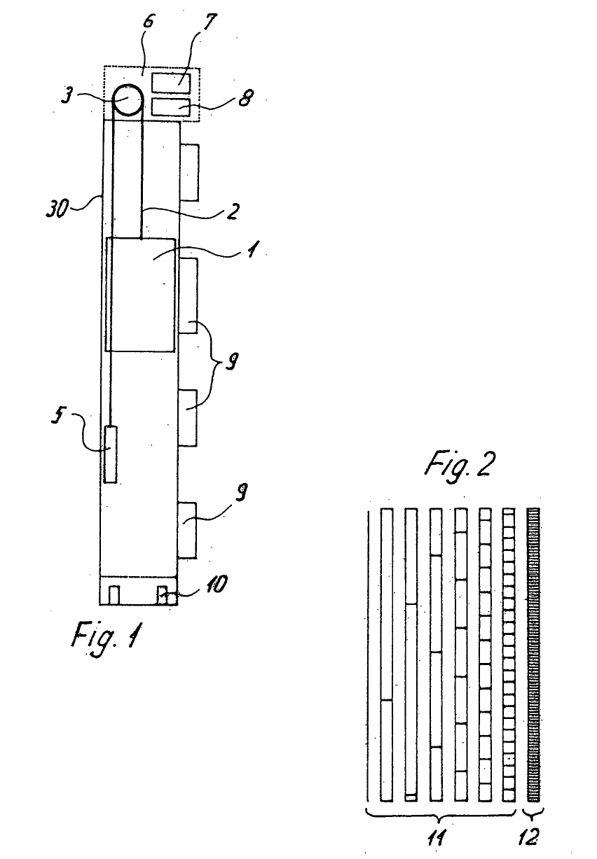

FIG. 2 provides examples illustrating coding for the scale. At least one absolute encoded scale 11 and one incremental scale 12 are applied to the scale. The absolute position is processed so as to be utilized for safety functions. From the incremental scale, information on speed and travel direction may be obtained, as can high-precision positional information for purposes related to comfort. The absolute encoded scale 11 may be provided with any type of code—specifically, however, a linear code, a Gray code, or a pseudo-random code.

It is especially advantageous if both scales have the same resolution. For example, it is conceivable that a resolution of, for example, 20 cm is sufficient for safety purposes. An elevator having short-term positional errors of <20 cm would accordingly not be unsafe. Comfort qualities frequently require much higher precision, for example, 1 mm. The incremental scale may be employed for this purpose. In addition, this scale is also relevant in terms of safety: the speed may be measured at smaller intervals or at higher resolution.

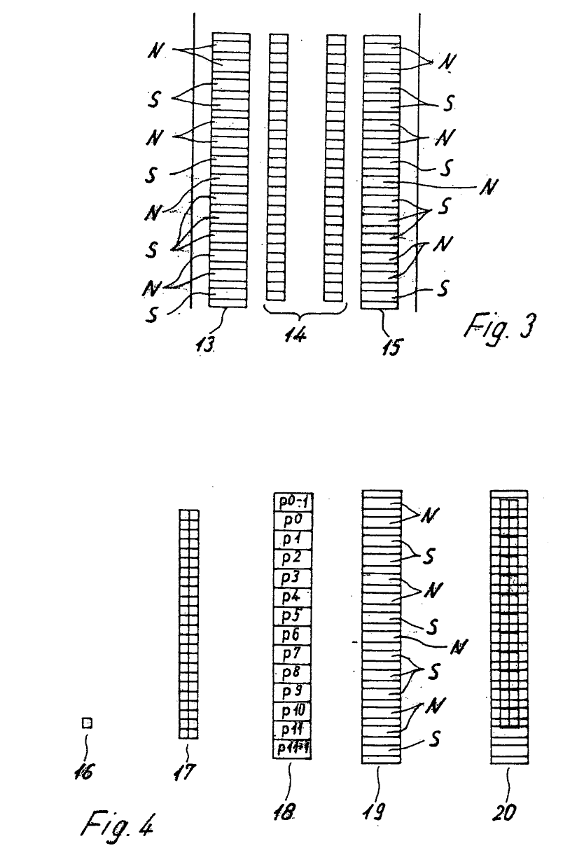

FIG. 3 provides an example of a pseudo-random code.

When using this code, the north and south poles are arranged in a linear fashion so as to produce a bit pattern running along the direction of travel. Any segment of a certain length viewed on this bit pattern does not reoccur over the entire length.

The maximum length of the scale and required positional precision determine the length of the segment to be viewed. On the left, an absolute scale of lengths is shown in which the magnetic surfaces are identified by N=north and S=south. Redundant incremental scales are located in the center, while at the right there is another redundant absolute scale with magnetic fields.

As an example, the following values are assumed to be encoded:

| | |
|---|---|
| Height of shaft: | 100 m |
| Desired resolution a: | 12 bit |
| Resulting number of steps: | Z = 2¹² = 4,096 |
| Length of a magnetic bit b: | b = h: Z = 24.4 mm |
| Physical length of code segment I: | I = b × a = 293 mm |

Given a resolution of 12 bits, the resulting length of an information unit is 24.4 mm, so that the scale must be read over a length of almost 30 cm. Along this length are 12 binary magnetic information units (bits) in the form of a north pole or south pole.

The flag for the pseudo-random code is that each section>12 bits from the linear bit sequence occurs only once over the length of the elevator shaft. If the viewing window is displaced by length b (1 bit), another unique bit combination is found along the length of the elevator.

FIG. 4 shows additional possible codes. The sensors are able to detect signals from the motion over the magnetic fields; for example, it is possible to provide a single Hall-effect device 16. Alternatively, it is also possible to combine several Hall-effect devices in one arrangement 17, and thus read this one 12-bit length of the scale.

Reference number 18 is a schematic view showing the longitudinal division along the magnetic tape of the scale.

A scale 19 with an applied magnetic code may be read by a Hall-effect device 16, or by an arrangement of Hall-effect devices 17, as is illustrated schematically by reference number 20. There the arrangement of Hall-effect devices 17 reads the magnetic code, thereby generating a snapshot.

The arrangement of sensors moves relative to the scale. For purposes of evaluation, a snapshot of I successive bits is required in order to be able to determine the exact location on the scale. This bit value may be unambiguously linked in a table to one physical length, for example, 23.8 m above the foundation of the shaft. Several sensors may be arranged so as to facilitate the read-out result for the evaluation whenever the direction of flow changes.

Since all possible bit combinations are allowed, a single bit error would result in a false absolute position. In the case of a two-channel evaluation, any discrepancy between the two channels would be detected, and the elevator would accordingly have to be shut down. Given additional measures within a channel, this channel alone is able to recognize a bit error, and even correct it as required, thereby enhancing the availability of the system. Conceivable measures of this type include:

redundant scanning by offset sensor elements

comparing the absolute position with the incremental scale

plausibility check relative to the previous position

simultaneous reading of adjacent positions (higher resolution required)

Another advantage of the position sensing system according to the invention relates to its reliable determination of position which simplifies initial start-up of an elevator. Instead of manual adjustment, as is the conventional approach of prior art, the adjustment may be effected by one reference trip. During a trip using the incremental control in a special operating mode, the system would move to a specific position, then this position would be signaled through an input by the start-up operator to the control system and stored there as a reference value. This procedure may be repeated for all positions.

This data input may be performed directly at the control system or control equipment; however, it is preferably performed directly from the car. A reliable interface between the position sensor and control or safety equipment serves this purpose.

The input device may be integrated into the inspection control system or implemented as a separate unit. One possible design integrates the inspection control system and position input device in a single operating terminal which includes input means and displays, specifically, in a hand-operated terminal with a permission switch such as those familiar from robotics and drive technology.

The system is furthermore distinguished by the fact that a plurality of data is available which contributes to the safe, reliable, and comfortable operation of the elevator. To this end, it is useful to have a data interface which allows for the transmission of definite and tentative data to other control and safety equipment. This interface preferably has the following characteristics:

the entire extent of the elevator system is able to be bridged

data transmission complies with the required safety standards

the total number of lines is low (for example using time-division multiplexing)

the real-time capability of the system is preserved.

As long as these requirements are met, the sensor may be movably installed on the car so as to support both safety-relevant functions and also comfort-related functions.

1. Position sensing system, specifically for elevators, comprising at least one sensor which is able to move relative to a transducer for the sensor, characterized in that a scale is provided as the transducer, to which scale a code (11-15, 19) detectable by the sensor is applied by which the position of the sensor relative to the scale is able to be measured.

2. Position sensing system according to claim 1, characterized in that detection of the position is effected by the sensor using a noncontact means.

3. Position sensing system according to claim 1 or 2, characterized in that the scale has multiple magnetic fields.

4. Position sensing system according to claim 1, characterized in that the scale has at least two different codes (11-15, 19) arranged so as to be adjacent to each other.

5. Position sensing system according to claim 1, characterized in that multiple sensors are provided by which redundant scanning of the one or multiple codes (11-15, 19) may be implemented.

6. Position sensing system according to claim 1, characterized in that a comparator is provided which compares the position and/or speed values measured by the two sensors.

7. Position sensing system according to claim 1, characterized in that a code (11-15, 19) has a scale of up to 2 mm.
